(19) United States
(12) Patent Application Publication
(10) Pub. No.: US 2014/0072470 A1
(43) Pub. Date: Mar. 13, 2014

(54) CONSOLIDATION OF EXCHANGE-COUPLED MAGNETS USING EQUAL CHANNEL ANGLE EXTRUSION

(71) Applicant: Advanced Materials Corporation, Pittsburgh, PA (US)

(72) Inventors: Suryanarayan G. Sankar, Pittsburgh, PA (US); Laszlo John Kecskes, Havre de Grace, MD (US)

(21) Appl. No.: 14/022,829

(22) Filed: Sep. 10, 2013

Related U.S. Application Data
(60) Provisional application No. 61/698,855, filed on Sep. 10, 2012.

(51) Int. Cl. H01F 41/02

(52) U.S. Cl. CPC H01F 41/0266
USPC 419/48; 419/67; 264/210.1

(57) ABSTRACT

The present invention employs Equal Channel Angular Extrusion (ECAE) to consolidate Fe₁₆N₂, Fe₄N, Sm₂Fe₁₇Nₓ, either alone or in combination with other magnetic powders made from Nd₂Fe₁₄B, SmCo₅, Sm₂Co₁₇, Sm₂Fe₁₇Nₓ and MnBi to prepare dense bodies at temperatures as low as room temperature or as high as 800° C., depending on the composition. When a soft magnetic material such as α-Fe powder or Fe₄N powder is mixed with a hard magnetic material such as Nd₂Fe₁₄B, SmCo₅, Sm₂Co₁₇ or Sm₂Fe₁₇Nₓ or MnBi or FeCr alloys or a semi-hard material such as Fe₁₆N₂, exchange-coupled magnets are obtained. This is due to the fact that the current theory on exchange-coupling phenomena indicates that a nanocrystalline size of the soft magnetic material is a necessary condition for the promotion of exchange-coupling.

### CROSS-REFERENCE TO RELATED APPLICATION

This application claims priority to provisional application Ser. No. 61/698,855, filed Sep. 10, 2012, incorporated by reference herein in its entirety.

### GOVERNMENT LICENSE RIGHTS

The U.S. government may have certain rights to this invention by virtue of Laszlo J. Kecskes, who is a joint inventor to this invention, being a U.S. government employee.

### FIELD OF THE INVENTION

This invention relates to the consolidation of magnet powders such as Fe₁₆N₂, Fe₄N, Sm₂Fe₁₇N₃, SmCo₅, Sm₂Co₁₇, and MnBi which are thermally sensitive, either alone or in combination with each other to prepare dense bodies at temperatures as low as room temperature or as high as 800° C., depending on the composition. This invention also relates to the consolidation of exchange-coupled permanent magnets such as Nd₂Fe₁₄NB—Fe, Nd₂Fe₁₄B—Fe₄N, Nd₂Fe₁₄B—Fe₁₆N₂, Sm₂Fe₁₄N₃—Fe₄N, Sm₂Fe₁₄N₃—Fe₁₆N₂, MnBi—Fe₄N, MnBi—Fe₁₆N₂ SmCo₅—Fe, and Sm₂Co₁₇—Fe to prepare dense bodies at temperatures as low as 600° C. or as high as 800° C.

### BRIEF DESCRIPTION OF THE DRAWINGS

Embodiments of the present invention will now be described, by way of example only, with reference to the accompanying drawings for the purpose of illustrating the embodiments, and not for purposes of limiting the invention, wherein:

FIG. 1 shows the fraction of the three phases, bcc Fe, Fe₄N and Fe₁₆N₂, depending on the process conditions, of an Fe₁₆N₂ starting material used for one embodiment of the present invention;

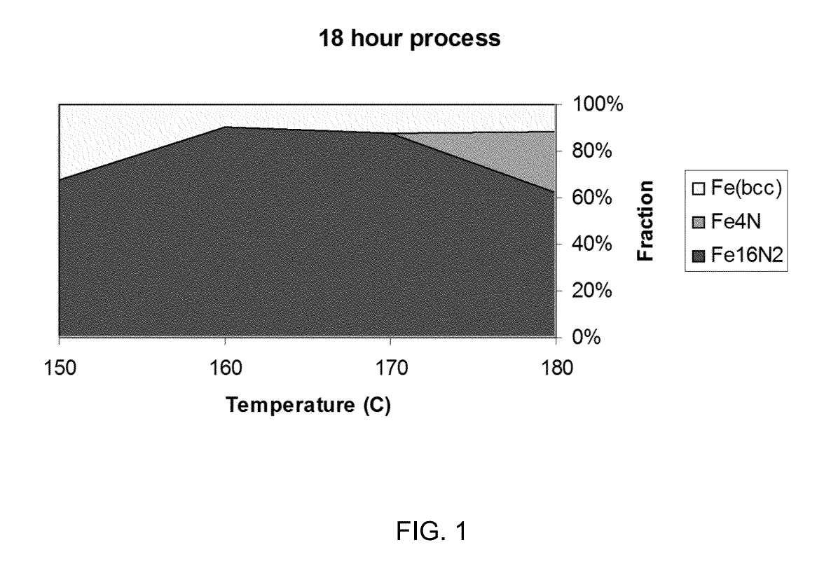

FIG. 2 shows the powder x-ray diffraction pattern of Fe₁₆N₂ illustrated in FIG. 1; and

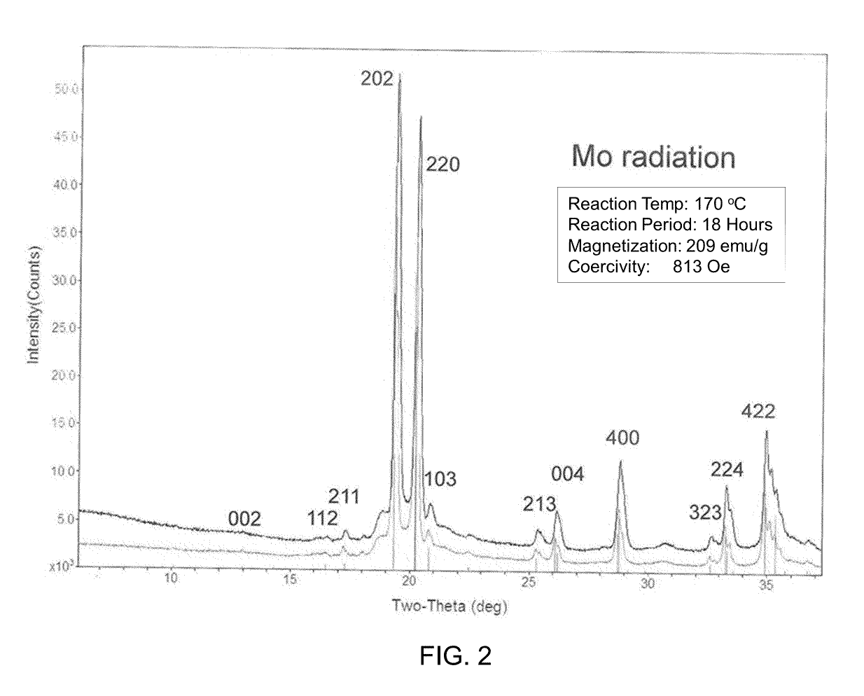

FIG. 3 is a plot of Magnetization (at an external magnetic field of 16 kOe) of reaction products as a function of ammonia in a mixture of ammonia and nitrogen at four different temperatures of Fe₁₆N₂ illustrated in FIG. 1.

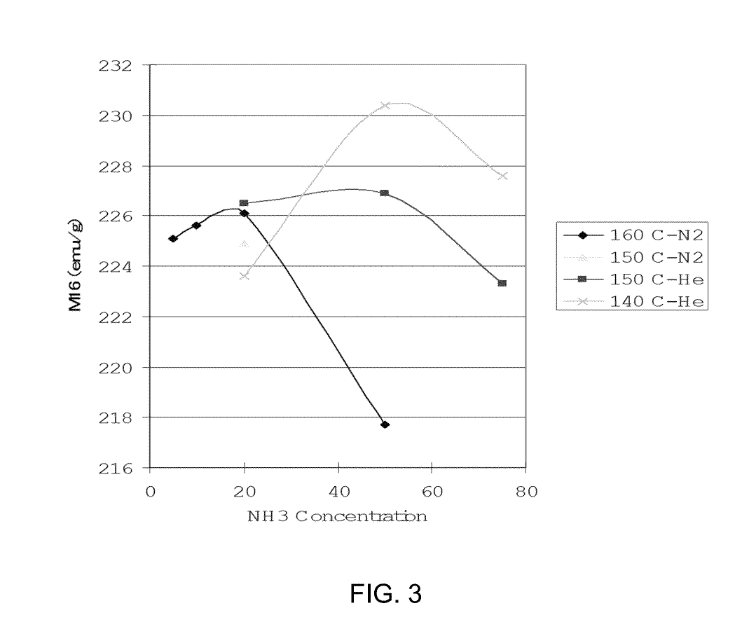

### DETAILED DESCRIPTION OF THE INVENTION

Other than in any operating examples, or where otherwise indicated, all numbers expressing, for example, quantities of ingredients, compositions, temperature ranges or time periods used in the specification and claims are to be understood as being modified in all instances by the term “about”. It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. In this application, the use of the singular includes the plural and plural encompasses singular, unless specifically stated otherwise. In addition, the use of “or” means “and/or” unless specifically stated otherwise, even though “and/or” may be explicitly used in certain instances.

A number of magnetic materials containing chemical compositions substantially described as Fe₁₆N₂, Fe₄N, MnBi, and Sm₂Fe₁₇N₃ are thermally sensitive and, therefore, powders made from them cannot be consolidated to full density through well-established powder metallurgical techniques that require treatments at temperatures as high as 1000° C. The present invention employs Equal Channel Angular Extrusion (ECAE) method to consolidate such powders at temperatures as low as 100 to 200° C. for Fe₁₆N₂ powders and between 300 and 400° C. for powders Fe₄N, MnBi, and Sm₂Fe₁₇N₃. Alternative embodiments of the present invention include temperature ranges selected from a group consisting of, including but not limited to, 100-150° C., 150-200° C., 100-125° C., 115-140° C., 130-155° C., 145-170° C., 160-185° C., and 175-200° C. See Table 1 for examples.

A number of magnetic materials containing chemical compositions substantially described as Nd₂Fe₁₄B, SmCo₅, and Sm₂Co₁₇ require at least 900° C., more preferably 1100° C. for consolidation to full density. The present invention employs Equal Channel Angular Extrusion (ECAE) method to consolidate such powders at temperatures between 600 and 800° C. Alternative embodiments of the present invention include temperature ranges selected from a group consisting of, including but not limited to, 600-700° C., 700-800° C., 600-650° C., 650-700° C., 700-750° C., 750-800° C., 600-625° C., 615-640° C., 630-655° C., 645-670° C., 660-685° C., 675-700° C., 690-715° C., 705-730° C., 720-745° C., 735-760° C., 750-775° C., 765-790, and 780-800° C. See Table 1 for examples.

TABLE 1
Extrusion Temperature range examples per composition.

| | |
|---|---|
| Fe₁₆N₂ | 100 to 200, preferably 175 to 200 |
| MnBi | 300 to 400, preferably 350 to 400 |
| Sm₂Fe₁₇Nx | 300 to 400, preferably 350 to 400 |
| Nd₂Fe₁₄B | 600 to 700, preferably 675 to 700 |
| Sm—Co | 700 to 800, preferably 750 to 800 |

The present invention also describes the production of consolidated solid bodies with substantially better result, close to full density using mixtures of powders described in the above paragraphs above employing Equal Channel Angular Extrusion technique at temperatures between 200 and 800° C. Alternative embodiments of the present invention include temperature ranges selected from a group consisting of ranges selected from a group any incremental ranges of, including but not limited to, +15° C. (e.g., 200-215° C.), +30° C. (e.g., 500-530° C.), +50° C. (e.g., 600-650° C.), +100° C. (e.g., 700-800° C.), +200° C. (300-500° C.), and +300° C. (500-800° C.). See Table 2 for examples.

TABLE 2
Excursion Temperature range examples per composition mixture.

| Composition | Temperature range (deg C.) |
|---|---|
| Nd₂Fe₁₄B—Fe | 600 to 800, preferably 700 to 750 |
| SmCo₅—Fe | 500 to 700, preferably 650 to 700 |
| Sm₂Co₁₇—Fe | 700 to 800, preferably 750 to 775 |
| Nd₂Fe₁₄B—Fe₄N | 600 to 700, preferably 675 to 700 |
| Nd₂Fe₁₄B—Fe₁₆N₂ | 500 to 700, preferably 600 to 650 |
| Sm₂Fe₁₄N₃—Fe₄N | 300 to 500, preferably 400 to 450 |
| Sm₂Fe₁₄N₃—Fe₁₆N₂ | 300 to 400, preferably 300 to 350 |
| MnBi—Fe₄N | 300 to 400, preferably 350 to 400 |
| MnBi—Fe₁₆N₂ | 300 to 350, preferably 325 to 350 |

The unique advantages of this Equal Channel Angular Extrusion method are:
1. Retention of volatile components such as nitrogen in Fe₁₆N₂ or in Sm₂Fe₁₇Nₓ or Fe₄N in the structure when the extrusion is carried out at or below 400° C.
2. Limited or no growth of the grains. Powders with nanocrystalline structure do not have a chance of growing into large grains. Thus, they retain some magnetic, electronic, and other properties that are unique to nanocrystalline phases.
3. Such a method helps in the formation of bulk structures with densities of 99 to 100% theoretical density.
4. More importantly, the ECAE method results in a bulk material with the formation of crystalline texture and thus, a corresponding alignment of the grains. This feature is very useful in fabricating uniaxial magnets that would increase the magnetization in one specific crystalline direction and therefore result in magnets with higher magnetic energy product.
5. When a soft magnetic material such as α-Fe powder or Fe₄N powder is mixed with a hard magnetic material such as Nd₂Fe₁₄B, SmCo₅, Sm₂Co₁₇ or Sm₂Fe₁₇Nₓ or MnBi alloys or a semi-hard material such as Fe₁₆N₂, exchange-coupled magnets are obtained. This is due to the fact that the current theory on exchange-coupling phenomena indicates that a nanocrystalline size of the soft magnetic material is a necessary condition for the promotion of exchange-coupling.

### Experimental

The present invention is a low temperature processing technology to consolidate magnetic powder of substantial composition of Fe₁₆N₂ at temperatures between 100 and 200° C. In a preferred embodiment of this invention, magnetic powder of substantial composition of Fe₁₆N₂ is packed into a rectangular or spherical container made of stainless steel or nickel or other common engineering metals or alloys including copper, monel, or inconel. The container is loaded into the Equal Channel Angular Extrusion press and is extruded at pressures ranging from 1,000 to 10,000 psi, more preferably between 5,000 and 8,000 psi and temperatures between 100 and 200° C. Furthermore, the container is extruded at rates ranging from 0.01 inch/s to 1 inch/s, more preferably, 0.1 inch/s to 0.5 inch/s. 90° or 180° longitudinal rotations of the container are made after each extrusion to impart the magnetic powder with a preferred texture and crystallographic orientation. These same rotations may be performed on subsequent passes or multiple steps or multiple extrusions. At the end of the extrusion process, the container is allowed to cool down to room temperature and the magnet body is machined out from the container.

In this invention, magnetic powder of substantial composition of Fe₁₆N₂, Fe₄N, MnBi, or Sm₂Fe₁₇N₃ is packed into a rectangular or spherical container made of stainless steel or nickel or other common engineering metals or alloys including copper, monel, or inconel. The container is loaded into the Equal Channel Angular Extrusion press and is extruded at pressures ranging from 0 to 100,000 psi, more preferably 1,000 to 50,000 psi, more preferably 1,000 to 10,000 psi, more preferably between 5,000 and 8,000 psi and temperatures between 300 and 400° C. Furthermore, the container is extruded at rates ranging from 0.01 inch/s to 1 inch/s, more preferably, 0.1 inch/s to 0.5 inch/s. Ninety or 180° rotations of the container after each extrusion to impart the magnetic powder with a preferred texture and crystallographic orientation may be performed on subsequent passes or multiple steps or multiple extrusions. At the end of the extrusion process, the container is allowed to cool down to room temperature and the magnet body is machined out from the container.

Also, in this invention, magnetic powder consisting of mixtures of powders with chemical compositions of substantially Nd₂Fe₁₄B—Fe, Nd₂Fe₁₄B—Fe₄N, Nd₂Fe₁₄B—Fe₁₆N₂, Sm₂Fe₁₄N₃—Fe₄N, Sm₂Fe₁₄N₃—Fe₁₆N₂, MnBi—Fe₄N and MnBi—Fe₁₆N₂ is packed into a rectangular or spherical container made of stainless steel or nickel. The container is loaded into the Equal Channel Angular Extrusion press and is extruded at pressures ranging from 0 to 100,000 psi, more preferably 1,000 to 50,000 psi, more preferably 1,000 to 10,000 psi, more preferably between 5,000 and 8,000 psi and temperatures between 200 and 800° C. Furthermore, the container is extruded at rates ranging from 0.01 inch/s to 1 inch/s, more preferably, 0.1 inch/s to 0.5 inch/s. Ninety or 180° rotations of the container to impart the magnetic powder with a preferred texture and crystallographic orientation may be performed. At the end of the extrusion process, the container is allowed to cool down to room temperature and the magnet body is machined out from the container. In these experiments, the relative composition of the mixed powder is varied between 1 and 99%, the total composition always adding to 100%. More preferably, the relative composition is maintained between 40 and 60%.

“Relative composition” as it relates to, for example, 1 and 99% means two possible compositions: i) 1% Nd₂Fe₁₄B and 99% Fe, or ii) 99% Nd₂Fe₁₄B and 1% Fe. The scope of the invention to any combination or increment (real number) of percentages between 1 and 99%, such as 2 and 98%, 5.5 and 94.5%. As mentioned above, the most preferably ranges of relative compositions are between 40-60%, which means any combination such as 41-59%, 42-58%, 45-55%, 50-50%, etc.

The magnetization of the consolidated Fe₄N body varies between 160 and 180 emu/g.

The energy product of Fe₁₆N₂ consolidated body varies between 4 and 20 MG Oe.

The energy product of MnBi or Sm₂Fe₁₇N₃ consolidated bodies vary between 30 and 45 MG Oe.

The energy product of Nd₂Fe₁₄B—Fe, Nd₂Fe₁₄B—Fe₄N, Nd₂Fe₁₄B—Fe₁₆N₂, Sm₂Fe₁₄N₃—Fe₄N, Sm₂Fe₁₄N₃—Fe₁₆N₂, Sm₂Co₁₇—Fe, SmCo₅—Fe, MnBi—Fe₄N and MnBi—Fe₁₆N₂ consolidated bodies vary between 30 and 60 MG Oe.

In summary, the present invention has many alternative embodiments that demonstrate the following characteristics, qualities, and behaviors, or relative composition or process steps, some of which are listed below:

A. A method to consolidate Nd₂Fe₁₄B, SmCo₅ and Sm₂Co₁₇ powders at temperatures below 800° C.

B. A method to consolidate mixtures of Fe₁₆N₂ and Nd₂Fe₁₄B powders, the relative compositions being 1 to 99% that exhibit exchange-coupling behavior.

C. A method to consolidate mixtures of Fe₁₆N₂ and MnBi powders, the relative compositions being 1 to 99% that exhibit exchange-coupling behavior.

D. A method to consolidate mixtures of Fe₁₆N₂ and alpha-iron powders, the relative compositions being 1 to 99%, at temperatures below 800° C. that exhibit exchange-coupling behavior.

E. A method to consolidate mixtures of and Nd2Fe14B and Fe₁₆N₂ powders, the relative compositions being 1 to 99% that exhibit exchange-coupling behavior.

F. A method to consolidate mixtures of Sm₂Fe₁₇Nₓ and alpha-iron powders, the relative compositions being 1 to 99%, at temperatures below 500° C.

G, A method, wherein ECAE processing, depending on the route history, imparts the consolidated material with a characteristic crystallographic texture and a unique morphology ranging from equiaxed to acicular.

H. A method, wherein ECAE is being performed wherein the powdered (particulate) mixtures are confined in a containment vessel and impart a hydrostatic pressure during consolidation.

I. A method, wherein the ECAE process affects the mixture differentially resulting in a functionally gradient microstructure.

J. The resulting extruded body having a density of above 95% and up to 100% of the theoretical density.

K. The grain size of the resulting body is above 20 nanometers and below 2 micrometers.

L. The energy product of the resulting body containing Fe₁₆N₂ ranges from 4 to 20 MG Oe.

M. The energy product of the resulting body containing MnBi ranges from 10 to 30 MG Oe.

N. The energy product of the resulting body containing Sm₂F₁₇Nₓ ranges from 20 to 40 MG Oe.

O. The energy product of the resulting body containing mixtures of Fe₁₆N₂ and MnBi and Fe₁₆N₂ and Sm₂F₁₇Nₓ ranges from 30 to 40 MG Oe.

P. The energy product of the resulting body containing Nd₂Fe₁₄B and MnBi or Nd₂Fe₁₄B and Fe ranges from 40 to 60 MG Oe.

Q. Products of the processes discussed above.

The examples provided herein are illustrative and not limiting, and other variations and modifications of the present invention are contemplated. Those and other variations and modifications of the present invention are possible and contemplated, and it is intended that the foregoing specification and the following claims cover such modifications and variations.

What is claimed is:

1. A method to consolidate magnetic powders, comprising the method steps of:
selecting a magnetic powder from the group consisting of Fe₁₆N₂, Sm₂Fe₁₇Nₓ, Fe₄N and MnBi;
placing the magnetic power into an Equal Channel Angular Extrusion press at a temperature at or below 800° C.; and
extruding the magnetic powder through the Equal Channel Angular Extrusion press to produce a solid body.

2. A method to consolidate magnetic powders, comprising the method steps of:
selecting a magnetic powder consisting of mixtures of powders from the group consisting of Nd₂Fe₁₄B—Fe, Nd₂Fe₁₄B—Fe₄N, Nd₂Fe₁₄B—Fe₁₆N₂, Sm₂Fe₁₄N₃—Fe₄N, Sm₂Fe₁₄N₃—Fe₁₆N₂, MnBi—Fe₄N and MnBi—Fe₁₆N₂;
placing the magnetic powder into an Equal Channel Angular Extrusion press at a temperature at or below 800° C.; and
extruding the magnetic power through the Equal Channel Angular Extrusion press to produce a solid body.

3. A method to consolidate magnetic powders, comprising the method steps of:
mixing a soft magnetic material with a hard magnetic material or a semi-hard material to form a magnetic powder;
placing the magnetic powder into an Equal Channel Angular Extrusion press at a temperature at or below 800° C.; and
extruding the magnetic powder through the Equal Channel Angular Extrusion press to produce a solid body,
whereby the solid body is an exchange-coupled magnet.
